(19) United States
(12) Patent Application Publication
(10) Pub. No.: US 2026/0340610 A1
(43) Pub. Date: Oct. 29, 2026

(54) SYSTEM AND METHOD FOR AUTOMATIC MOBILE SELF-CHECKOUT AND VERIFICATION USING CAMERAS AND SCANNABLE TOKENS

(71) Applicant: CARNEGIE MELLON UNIVERSITY, Pittsburgh, PA (US)

(72) Inventors: Anudeepsekhar Bolimera, Pittsburgh, PA (US); Zhantao Yang, Pittsburgh, PA (US); Marios Savvides, Pittsburgh, PA (US)

(73) Assignee: CARNEGIE MELLON UNIVERSITY, Pittsburgh, PA (US)

(21) Appl. No.: 19/659,138

(22) Filed: Apr. 27, 2026

Related U.S. Application Data
(60) Provisional application No. 63/794,781, filed on Apr. 25, 2025.

(51) Int. Cl. G06Q 20/18; G06Q 20/40

(52) U.S. Cl. CPC G06Q 20/18; G06Q 20/401

(57) ABSTRACT

Disclosed herein are systems and methods for automatically verifying a mobile-based self-checkout process for a frictionless and accurate checkout experience. The disclosed invention utilizes a combination of computer vision-based product detection and recognition to enable the shopper to shop for products in a frictionless manner while at the same time protecting the merchant against bad actors.

### RELATED APPLICATIONS

This application claims the benefit of U.S. Provisional Patent Application No. 63/794,781, filed Apr. 25, 2025, the contents of which are hereby incorporated herein in their entirety.

### BACKGROUND

Retailers have long sought to streamline the checkout process to reduce customer wait times and operational costs, and to control inventory. Existing checkout systems rely on manual scanning at cash registers or self-checkout kiosks, which can be cumbersome and prone to human error. Various mobile checkout solutions using handheld scanning devices exist but often rely on manual scanning of item barcodes by the customer without effective verification that the items in the customer's cart correspond to the barcode scanned by the handheld scanning device.

Additionally, a substantial hurdle in implementing frictionless self-checkout solutions is the risk of theft. It is difficult to ensure that the systems are not exploited by bad actors. This problem is especially prominent for checkout solutions which use a handheld scanning device, wherein the shopper does not have to come to a self-checkout station or a checkout counter. Accordingly, there is a need for a self-checkout system that ensures shopped items are quickly and accurately verified and checked out, reducing theft and shrinkage.

### SUMMARY OF THE INVENTION

Disclosed herein are systems and methods for automatically verifying a mobile-based self-checkout process for a frictionless and accurate checkout experience. The technology described herein may utilize computer vision-based product detection and recognition to enable the shopper to shop for products in a frictionless manner while at the same time protecting the merchant against bad actors.

Some embodiments may include systems and methods for mobile-based self-checkout of items in a retail environment, and for verifying that items purchased match those physically taken from the store, using a combination of biometrics, scannable tokens and/or codes, barcode data storage, and/or camera-based (computer vision) verification.

Some embodiments may include comprehensively integrated camera-based verification (whether from handheld devices, in-store cameras, or any other camera types or systems), combined with dynamically generated scannable tokens or codes (e.g., a QR code) as both a receipt record and item verification token.

Some embodiments may include using a handheld mobile device capable of reading and/or generating barcodes, QR codes or any form of scannable token or code, along with an in-store, handheld, and/or other type of camera verification that automatically confirms each item being purchased.

Some embodiments may include systems and methods for enabling customers to self-checkout items in a retail store using a personal handheld device (for example, including, but not limited to, a smartphone, tablet, or other mobile computing device).

Some embodiments may include a user completing a virtual “checkout” (and payment) in the mobile application, resulting in a unique scannable token being generated on the device that encodes information identifying the transaction and associated barcodes of the purchased items.

Some embodiments may include a scannable token or code which may be scanned by a handheld device (for example, including, but not limited to, store associate devices, and/or store-provided scanners) and/or by fixed, mounted cameras at the store exit, to retrieve the corresponding transaction and/or items list.

Some embodiments may include customers being able to identify themselves using biometrics (for example, to link to an app or account for purposes including, but not limited to, payment).

Some embodiments may include using cameras to capture images of a customer's items (e.g., in a shopping cart, bag, basket, or on the user's person) and computer vision algorithms to detect and recognize each item.

Some embodiments may include comparing recognized items with barcodes linked to a scannable token and/or code, and the system automatically verifying that the physical items match the digital transaction record, thereby reducing theft and errors.

Some embodiments may include a mobile app executing a personal mobile computing device (e.g. a smartphone, tablet, etc.) or any handheld scanning device for item scanning and checkout, which may allow customers to scan or otherwise add items to a digital cart and optionally pay via the device.

Some embodiments may include a transaction-linked scannable token, and/or code generation, wherein upon checkout, the system may bundle the item barcode data, pricing, and transaction information into a scannable token and/or code displayed on a device.

Some embodiments may include automated storage of barcodes and receipt data, wherein a backend server or cloud service may securely store lists of purchased items, associated barcodes, timestamps, and/or other transaction details.

Some embodiments may include camera-based item verification. In some embodiments, verification may include a store associate scanning the scannable token and/or code and using a handheld camera to confirm items; and/or a mounted/fixed camera scanning the scannable token and/or code from the device screen and simultaneously capturing images of items in the cart. In other embodiments, the camera-based item verification may include cameras mounted in-store or on the user's shopping cart that verify items that are placed into the shopping cart.

Some embodiments may include computer vision and machine learning, where advanced machine learning based algorithms for product detection, recognition, and/or mismatch identification may ensure that the items physically observed match the digital record.

Some embodiments may include a workflow wherein a barcode is automatically scanned from the item and the item visually verified, when the item is placed into the user shopping cart, thereby eliminating the need for a handheld device.

### DEFINITIONS

As used herein, the term “camera” should be interpreted broadly to include any type of sensor used to collect the required information, regardless of whether or not an actual “image” is produced by the sensor. For example, a camera may be a single image camera or video camera or a scanner capable of capturing barcodes, QR codes or any other type of scannable token. Further, any use of the term “camera” herein is not intended to be limited in any way as to the type of images gathered or the means of gathering the images.

### BRIEF DESCRIPTION OF THE DRAWINGS

By way of example, specific exemplary embodiments of the disclosed system and method will now be described, with reference to the accompanying drawings, in which:

FIG. 1 is a schematic diagram showing a system architecture of an example embodiment, including a consumer's mobile device, in-store cameras, a backend server, and optional store associate devices.

FIG. 2 shows a flowchart of an example embodiment, including an overall workflow of scanning items, generating a QR code or scannable token, and verifying the transaction with camera input.

### DETAILED DESCRIPTION

### System Overview

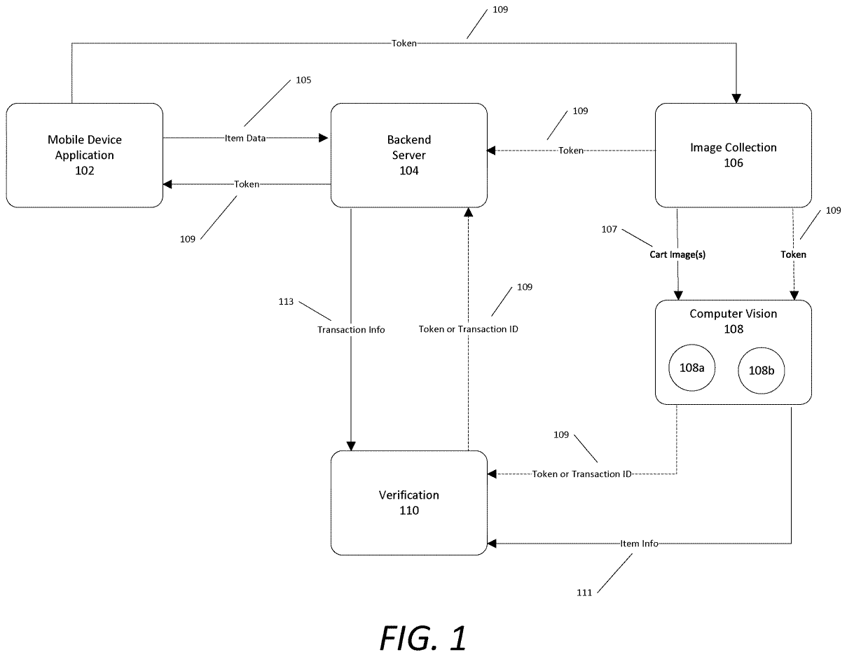

FIG. 1 shows an overall system overview of an example embodiment of the invention.

### Mobile Device Application (102)

Some embodiments may include a mobile device application 102 that maintains a virtual shopping cart and may, in some embodiments, handle in-app payments. Application 102 may run on iOS, Android, or other operating systems. Application 102 may incorporate biometric features which facilitate customer login (for example, to an account), identification, checkout, and/or rewards/loyalty programs.

Application 102 may provide an interface to take a picture of the product (e.g., via a camera incorporated within the device), or scan (e.g., via the camera) item barcodes. Alternatively, item barcodes may be looked-up, for example, via a product search function in the application. Upon checkout, application 102 may update the scanned product details to a backend server 104 and retrieve (or locally generate) a unique token (i.e., the transaction ID) 109 embedded into a scannable indicia, The scannable indicia 109 may reference a cloud-based and/or local database entry containing item barcodes, timestamps, pricing, etc. of each item involved in the transaction (i.e., item data 105).

### Backend Server (104)

Some embodiments may include a backend server 104. Server 104 may maintain a secure database of transaction data, linking a unique QR code and/or scannable indicia 109 to an item list, prices, purchase confirmation, timestamps and/or other information (item data 105). Server 104 may receive data from the mobile application/device 102 in real-time (for example, data may include, but are not limited to, item additions, deletions, and/or total cost calculations). Server 104 may facilitate analytics and potential integration with store inventory systems, loyalty programs, etc., and may also provide item information and verification.

### Verification Cameras and Systems (106)

Some embodiments may include an image collection capability 106, which may include verification cameras and systems. Image collection 106 may be a handheld verification device, mounted camera verification devices, or a combination. For handheld verification, a store associate may use a handheld device that scans the token 109 from the mobile device application 102 executing on a customer's device or a store-provided device.

For mounted camera verification, overhead, exit-mounted, shopping cart-mounted or other cameras may scan the mobile device screen of the mobile device application 102 and may read token 109 therefrom and may simultaneously capture images/video of the items being carried or carted out via image collection capability 106. In one embodiment, a camera associated with the mobile device application 102 may capture images of the customer's items.

The system may use a computer vision algorithm 108 to detect, recognize, and match item barcodes. The system's algorithms may compare recognized SKUs/products to the database record associated with token 109.

### Computer Vision and Machine Learning (108)

Some embodiments may include the use of computer vision and machine learning 108. In some embodiments, 108 may include a set of algorithms and methods to identify the scannable tokens in item data 105 and products presented to the image collection (i.e., cameras/system) 106. This may include identifying token 109 presented to the system and sending a either token 109 or a transaction ID encoded in token 109 to the backend server 104.

Advanced product detection models 108 may be used to detect the shopped products in a customer's cart, basket, bag, or on their person. A machine learning model for product identification may then be used to “templatize” each detected product. Each detected template may then be compared against an extensive gallery of precomputed templates of all products in the store to identify the detected product. Occluded products or detections with lower confidence may be handled by a reverse lookup algorithm that checks for the closest matches to the occluded detection, within the precomputed templates of the products in the transaction.

### Verification (110)

A verification step/component 110 verifies the transaction info 113. Verification comprises matching scanned barcodes 105 from items (now part of transaction info 113) with images 107 of items in the user's cart (or otherwise collected). Here, the identified item information (UPC codes) 111 and token 109 or a transaction ID decoded from token 109 are obtained. The transaction ID may be used to retrieve transaction information 113 (for example, including, but not limited to, UPCs of the shopped items) from backend server 104. The identified item info 111 (e.g., UPC codes) may be checked against the UPCs in transaction info 113 for any discrepancies. If no discrepancies are found, the system may allow the shopper to proceed with checkout. If any discrepancies are found, appropriate action may be prompted in accordance with the business'rules/policy.

### Verification Process

The product verification system may leverage a combination of computer vision, machine learning, and backend transaction matching to validate that a customer's physical items match their digital purchase record. The verification pipeline may include the following steps:

### 1. Token and Transaction Identification

Some embodiments may include a token 109 and transaction identification step. At the exit or verification checkpoint, the customer may present token 109 to the system and token 109 may be imaged by image collection module 106. Token 109 may uniquely represent the completed transaction. The verification system 110 may identify token 109 using specialized recognition algorithms, decode token 109 to extract a transaction ID, and send transaction ID 109 to backend server 104 to retrieve the list of purchased items (transaction info 113), which may be stored as UPC codes. Alternatively, backend server 194 may receive the token 109 from verification model 110 or the image collection module 106 and decode the token 109 to retrieve the transaction ID. Alternatively, token 109 may be decoded at verification module 110 and the transaction ID sent to backend server 104.

### 2. Visual Product Detection and Template Matching

Some embodiments may include a visual product detection and template matching step. Once the transaction info 113 is retrieved, the system may initiate a visual verification process. Cameras (for example, including, but not limited to, overhead and/or side-mounted cameras) 106 may capture live images of the customer's cart or basket. Advanced product detection models 108a may identify individual items within the captured images. A machine learning-based product identification model 108b may extract features from each detected item and create a “template” (a unique visual signature). Each template may be compared against a precomputed gallery of templates corresponding to all products in the store to determine the identity of each product. This gallery may be built using images associated with every known UPC.

### 3. Reverse Receipt Lookup for Ambiguous or Occluded Items

Some embodiments may include a reverse receipt lookup step to deal with ambiguous or occluded items. This may be used for items that are partially occluded, poorly lit, or captured at unusual angles. The system may use a reverse receipt lookup algorithm. This process may attempt to match the visual crop of a detected item against the standard UPC image from the purchase record. If the confidence score is low or inconclusive due to occlusion or angle, the algorithm may attempt a reverse lookup using multi-view enrolled product images (captured from multiple orientations during setup). This multi-view product enrollment may ensure that even rotated or partially visible products can be accurately identified, reducing false positives or false alarms.

### 4. Verification and Outcome Matching

Some embodiments may include a verification and outcome matching step. Once all products are detected and identified 108, the identified product UPCs from camera analysis may be compared against the UPCs in the transaction record at verification module 110, which have been retrieved using the transaction IOD decoded from token 109. The system may check for any mismatches in quantity, category, or identity. If all items match, the verification may be considered successful, and the customer may be allowed to exit. If discrepancies are detected (e.g., extra, missing, or mismatched items), a flag may be raised. Depending on the store's policies, this could potentially result in a prompt to rescan a specific item, notification to a store associate for a manual check, a system alert for further investigation, or any other appropriate intervention.

### Operation Workflow

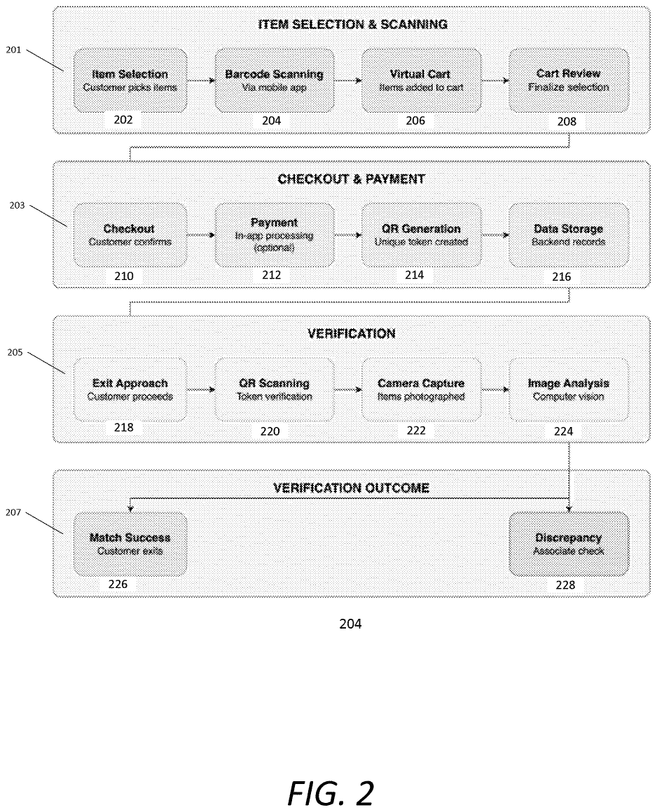

FIG. 2 shows the operational workflow of an example embodiment.

In some embodiments, an item selection and scanning step 201 may include the following sub-steps. First, the customer selects an item from a shelf or other display 202. The customer then scans the item's barcode or other indicia at 204, using the store's mobile app (running on a provided device or on the customers mobile device). Alternatively, computer vision or a search function within the app may be used to identify products.

Each scanned item may be added to a virtual digital cart in real time. Product details may be pulled from the store's product catalog. After selecting all items, the customer may review the virtual cart to finalize the selection 208.

A checkout and payment step 203 may include the following sub-steps. First, checkout 210, wherein the customer may confirm the correctness of the item list and proceed to checkout. The customer may then initiate payment at 212, wherein payment may be made using the mobile app, using stored payment credentials or another preferred method. The store or business may have discretion on whether or not to enable this feature or require the customer to pay at a kiosk or other cashier station. At 214, token 109 is generated, immediately after checkout or payment. Token 109 may include or reference item data 105 including, but not limited to, item barcodes, a transaction ID, a timestamp, and store location. Lastly, the full transaction record 113 may be securely stored at 216 in the backend server 104, including item data 105. A minimal copy may also be saved locally on the customer's device for reference.

The transaction is thereafter verified at 205. The verification process starts as the customer approaches the exit point of the venue at 218. The exit may include a verification checkpoint. Token (e.g., a QR code) 109 is displayed on mobile device 102 and scanned 220 using a handheld scanner and/or automated system (e.g., image collection 106) for transaction verification. At 222, one or more images of the customer's cart (or of the purchased products) are captured by image collection module 106. The image collection module 106 may be mounted (for example, in the store, on the cart, etc.), and/or handheld (for example, by a store associate). This may occur simultaneously with scanning 202 of token 109. The image is then analyzed at 224 by verification module 110, which may use image identifications made by computer vision algorithms 108, which analyze the captured images to detect and identify the items using trained machine learning models 108a, 108b. Each detected item may be matched against the product catalog using visual features and corresponding barcodes.

The outcome of the verification process 205 is expressed at 207. The verification outcome may include match success 226 or discrepancy 228.

For a match success outcome 226, all items physically present match the transaction record (for example, in terms of quantity, identity, and category), and the customer may be cleared to exit. If there are discrepancies at 228, a flag is raised and handled pursuant to the policies of the store. A discrepancy outcome 228 may result when at least one mismatch is found, which may trigger an alert for further verification (e.g., manual verification by a store associate, or other procedures determined by store policy).

Different camera configurations may be used during the verification process. For example, in some embodiments, cameras may be mounted overhead at store exits. In some embodiments, cameras may be on portable or handheld devices (for example, including, but not limited to, phones, tablets, and others). In some embodiments, cameras may be mounted on stationary kiosks that automatically scan both the QR code (and/or token) and the cart's contents. These configurations may be used by themselves, in combination, or deployed alongside other configurations.

Some embodiments may include the continuous validation of carts, wherein real-time validation of items occurs during shopping using cameras mounted directly on the shopping cart (and/or on a bag, on the shopper's person, on self-checkout units, exits, etc.). In some embodiments, the continuous validation of carts may include the following elements: cart association, product scanning, and item validation. During cart association, the customer may begin by scanning a code or scannable token to associate themselves with a specific cart. During product scanning, the customer may use a mobile device to scan product barcodes or rely on automated product detection through the cart-mounted cameras. During item validation, as products are added to the cart, the mounted camera(s) may continuously monitor and capture visual data. This data may be processed in real-time to validate the items being shopped. In some embodiments, the barcodes of the products may be scanned when the products are placed into the cart, eliminating the need for a mobile scanning application.

Some embodiments may include enhanced machine learning modules. In some embodiments, modules may be trained on brand packaging variants, for example, including, but not limited to, seasonal packaging or different sizes. Some embodiments may include AI-based product shape and weight analysis (for example, if integrated with weight sensors in the floor or cart).

Some embodiments may include security measures and/or encryption. For example, QR code data may be encrypted to prevent tampering, and secure communication protocols (SSL/TLS) may be used between the mobile device, cameras, and backend server.

Some embodiments may incorporate various “extended use” cases, including, but not limited to, curbside pickup or “Scan and Go” style checkouts (for example at warehouse stores), integration with loyalty reward programs (including, but not limited to, offering personalized promotions). Advanced analytics, for example, including, but not limited to, store heat maps of item selection behavior, may also be incorporated.

Some embodiments may feature integration with store inventory. For example, automatic real-time deduction from inventory may occur as items are scanned. Some embodiments may include alerts for out-of-stock or restricted merchandise requiring associate approval.

In some embodiments, the mobile app used by the customer may be installed on a store-provided device (as an alternative to a customer's personal handheld device).

In some embodiments, the aspects described herein may be used for shrink detection(i.e., theft).

In some embodiments, the aspects described herein may be used in applications including, but not limited to, automated self-checkout applications.

In some embodiments, the aspects described herein may be used in applications including, but not limited to, retail point-of-sale (POS) and self-checkout systems.

As would be realized by one of skill in the art, many variations on implementations discussed herein which fall within the scope of the invention are possible. The invention is not meant to be limited to the particular exemplary embodiments disclosed herein. Moreover, it is to be understood that the features of the various embodiments described herein were not mutually exclusive and can exist in various combinations and permutations, even if such combinations or permutations were not made express herein, without departing from the spirit and scope of the invention. Lastly, various portions of the disclosed method may be executed on various hardware devices that may be the same hardware devices or different hardware devices. For example, backend server 104 may perform the functions of the backend server as well as the functions of the verification module 110. Accordingly, the specific methods disclosed herein are not to be taken as limitations on the invention but as an illustration thereof.

1. A method of verifying a transaction of a shopper at a store comprising:
receiving, at a first device, from a second device, identifying information regarding one or more items;
building a list representing the transaction, the list comprising the identifying information of the one or more items;
generating a token representing the transaction and sending the token to the second device;
receiving the token from a third device;
receiving images containing one or more of the one or more items;
identifying, using a trained machine learning model, items in the received images; and
checking each identified item to determine if identifying information of the item appears in the list.

2. The method of claim 1 wherein the first device is a backend server and the second device is a mobile computing device.

3. The method of claim 2 wherein the identifying information is collected from the one or more items using the second device as the shopper collects the one or more items.

4. The method of claim 2 further comprising:
generating a total payment price for the one or more items; and
accepting a means of payment for the one or more items.

5. The method of claim 1 wherein the received images are collected by one or more cameras as the shopper collects the one or more items.

6. The method of claim 5 wherein the shopper places the items into a shopping cart as they are collected by the shopper and scanned by the second device and further wherein images of the items are collected by one or more cameras mounted on the shopping cart.

7. The method of claim 5 wherein the images of the items are collected by one or more stationary cameras as the shopper picks items from a shelf.

8. The method of claim 1 wherein the token is a scannable indicia identifying the list of items.

9. The method of claim 8 wherein the third device scans the token prior to the shopper exiting the store.

10. The method of claim 9 wherein the shopper places the items into a shopping cart as they are collected by the shopper and further wherein the images containing one or more of the one or more items comprise images of the shopping cart collected via one or more cameras.

11. The method of claim 10 wherein items are detected in the one or more images by trained object detector and further wherein the detected items are identified by a trained object recognition model.

12. The method of claim 11 wherein ambiguous or occluded items in the one or more images are handled by a reverse lookup process wherein unmatched items from the list are used to retrieve enrolled product images from multiple orientations to compare to the ambiguous or occluded items in the one or more images.

13. The method of claim 1 wherein the transaction is verified when all items in the list are matched with items identified in the one or more images.

14. The method of claim 1 wherein the transaction is unverified if any items in the list is not matched with an item identified in the one or more images within a predetermined degree of confidence.

15. A system for verifying a transaction of a shopper at a store comprising:
one or more handheld mobile devices used by shoppers to scan identifying indicia of items in the store;
a backend server for receiving the identifying indicia and placing the identifying indicia in a list representing the transaction; a verification device for verifying the transaction;
one or more cameras; and
software partially executing on the one of more handheld mobile devices, the backend server and the verification device, the software implementing the method of claim 1.

16. The system of claim 15 wherein the one or more cameras are mounted on a shopping cart, wherein the shopper places the items into the shopping cart as they are collected by the shopper and scanned by the second device, and further wherein images of the items are collected by the one or more cameras as the items are placed into the shopping cart.

17. The system of claim 15 wherein the images of the items are collected by the one or more cameras as the shopper picks items from a shelf.

18. The system of claim 15 wherein the shopper places the items into a shopping cart as they are collected by the shopper and further wherein the images containing one or more of the one or more items comprise images of the shopping cart containing the items, collected via the one or more cameras.

19. The system of claim 15 further comprising:
a trained object detector for detecting items in the one or more images; and
a trained object recognition model for identifying the detected items.

20. The system of claim 19 wherein ambiguous or occluded items in the one or more images are handled by a reverse lookup process wherein unmatched items from the list are used to retrieve enrolled product images from multiple orientations to compare to the ambiguous or occluded items in the one or more images.
